(19) United States
(12) Patent Application Publication
(10) Pub. No.: US 2009/0010139 A1
(43) Pub. Date: Jan. 8, 2009

(54) OPTICAL PICKUP

(75) Inventor: Tatsushi KOJIMA, Higashihiroshima-shi (JP)

Correspondence Address: MORRISON & FOERSTER LLP, 1650 TYSONS BOULEVARD, SUITE 400, MCLEAN, VA, 22102, US

(73) Assignee: SHARP KABUSHIKI KAISHA, Osaka-shi (JP)

(21) Appl. No.: 12/037,650

(22) Filed: Feb. 26, 2008

(30) Foreign Application Priority Data
Mar. 27, 2007 (JP) 2007-082005

(51) Int. Cl. G11B 7/00

(52) U.S. Cl. 369/112.23; G9B/7

(57) ABSTRACT

An optical pickup comprising: an objective lens 16 for converging laser light and directing it to an information recording medium 17; a rotational frame member 19 which surrounds the periphery of the objective lens 16, has a circular-shaped outer peripheral edge around an optical axis of the objective lens 16 and rotates in conjunction with the objective lens 16; a lens holder 15 which has a concave stepped portion 10 for rotatably supporting the rotational frame member 19 and is coupled to the rotational frame member 19 after rotation adjustments; and a protruding portion 20 protruded from the rotational frame member 19 toward the information recording medium 17.

The optical pickup can facilitate operations for adjusting the rotation of the objective lens and certainly prevent both the objective lens and the information recording medium from being damaged.

### CROSS-REFERENCES TO RELATED APPLICATION

This application is related to Japanese Patent Application No. 2007-82005 filed on Mar. 27, 2007, whose priority is claimed under 35 USC § 119, the disclosures of which are incorporated by reference in its entirety.

### BACKGROUND OF THE INVENTION

1. Field of the Invention

The present invention relates to optical pickups and information recording/reproducing devices. More particularly, the present invention relates to an optical pickup capable of recording, reproducing and erasing signals to and from an information recording medium such as a CD, a DVD or a next-generation optical disk system which uses blue laser, and an information recording/reproducing device including the optical pickup.

2. Description of the Related Art

FIGS. 10 to 12 illustrate an optical pickup which employs an integrated light receiving/emitting device for recording, reproducing and erasing information to and from both a CD and DVD or any one of these recording mediums, as an exemplary conventional optical pickup (hereinafter, referred to as an optical pickup device, in some cases).

FIG. 10 is a schematic explanation view of the entire structure of the conventional optical pickup, FIG. 11 is a plan view of FIG. 10, and FIG. 12 is a main-part cross-sectional view of FIG. 11.

In FIG. 10, radiated light emitted from an integrated light receiving/emitting device (11) is reflected by or passed through a dichroic prism (12), then is converted into parallel light by a collimate lens (13) and then is reflected upwardly by a turn-up mirror (14). Thereafter, the parallel light is passed through a condenser lens (16) as an objective lens which is mounted to a drivable and controllable lens installation table (15), which causes the parallel light to be converted into converged light and to be converged and reflected at a single point on an optical disk (17) as a recording medium.

Then, the reflected light is passed through the condenser lens (16), again, to be converted into parallel light, then is reflected by the turn-up mirror (14), then is passed through the collimate lens (13), then is reflected by or passed through the dichroic prism (12) and is returned to the integrated light receiving/emitting device (11) along the path opposite from the forward path.

The returned light is divided by a diffraction grating at the surface of the integrated light receiving/emitting device (11) and reaches a light receiving portion which converts the optical signals into electric signals to be used for reproducing, recording and erasing information or used as serve signals. Further, “18” designates a housing of the optical pickup.

Optical pickups having structures as described above have been required to record and reproduce information to and from optical disks with a higher-quality spot, in order to be adaptable to car navigation systems to be incorporated in automobiles, which have been increasingly demanded in recent years, or next-generation optical disk systems which treat information with higher densities using blue layer.

Further, each objective lens has been mounted to a lens installation table after setting the lens attachment position to such an orientation as to minimize the influence of birefringence at the resin lens, which has induced variations of the performance thereby inducing reduction of the yield, since the orientation of the lens is secured depending on the combination of various types of optical components (such as lenses, mirrors and prisms).

In order to address this, it has been suggested that an objective lens (condenser lens) in such an optical pickup is installed rotatably with respect to a lens holder (lens installation table) about the optical axis thereof and, thereafter, the objective lens is directly rotated and positioned in such a way as to minimize the influence of birefringence at each objective lens (refer to Japanese Unexamined Patent Publication No. 2004-253080).

On the other hand, in the optical pickup in FIGS. 11 and 12, the objective lens (16) is brought into proximity to the optical disk (17), which may cause them to impinge on each other, thereby causing them to be damaged by each other. Therefore, in order to prevent the impingement, it has been suggested that the lens holder (15) is provided with a protruding stopper portion (20). Further, “21” designates a balancer for suppressing oscillations of the ACT for adjusting the center of gravity. An exemplary literature which suggests such a stopper portion in an optical pickup having a structure as described above is Japanese Unexamined Patent Publication No. 2002-197704.

### SUMMARY OF THE INVENTION

It is a main object of the present invention to provide an optical pickup capable of certainly protecting an objective lens and an optical disk while having high quality.

According to the present invention, there is provided an optical pickup including:

an objective lens for converging laser light and directing it to an information recording medium;

a rotational frame member which surrounds the periphery of the objective lens, has a circular-shaped outer peripheral edge around an optical axis of the objective lens and rotates in conjunction with the objective lens;

a lens holder which has a concave stepped portion for rotatably supporting the rotational frame member and is coupled to the rotational frame member after rotation adjustments; and

a protruding portion protruded from the rotational frame member toward the information recording medium.

According to the present invention, there is provided the rotational frame member which surrounds the periphery of the objective lens, has a circular-shaped outer peripheral edge around an optical axis of the objective lens and rotates in conjunction with the objective lens for enabling adjustments of the rotation of the objective lens, and also the rotational frame member is provided with the protruding portion, which can prevent the objective lens from directly impinging on the information recording medium at portions near the objective lens and around the peripheral edge of the objective lens, thereby facilitating operations for adjusting the rotation of the objective lens and certainly preventing both the objective lens and the information recording medium from being damaged.

According to another aspect of the present invention, there is an information recording/reproducing device for reproducing or/and recording information by converging laser light emitted from a laser device, directing it to an information recording medium and receiving the light reflected by the information recording medium, the information recording/reproducing device comprising:

the above described optical pickup; and

a table being adapted such that an information recording medium can be mounted thereon and the laser light can be directed to the information recording medium through the objective lens in the optical pickup.

### BRIEF DESCRIPTION OF THE DRAWINGS

FIG. 1 is a schematic explanation view illustrating the entire structure of a first embodiment of an optical pickup according to the present invention;

FIG. 2 is a plan view of FIG. 1;

FIG. 3 is a main-part enlarged cross-sectional view of FIG. 2;

FIG. 4 is a main-part enlarged plan view of FIG. 2;

FIG. 5 is a view illustrating a second embodiment of the optical pickup of the present invention, corresponding to FIG. 4;

FIG. 6 is a structural explanation plan view illustrating a third embodiment of the optical pickup of the present invention, illustrating an objective lens, a rotational frame member and a state where they are assembled, from the left side;

FIG. 7 is a main-part enlarged view illustrating a fourth embodiment of the optical pickup of the present invention;

FIG. 8 is a view illustrating a fifth embodiment of the optical pickup according to the present invention, corresponding to FIG. 7;

FIG. 9 is a view of a fifth embodiment, corresponding to FIG. 2;

FIG. 10 is a schematic explanation view of the entire structure of a conventional optical pickup;

FIG. 11 is a plan view of FIG. 10; and

FIG. 12 is a main-part cross-sectional view of FIG. 11.

### DETAILED DESCRIPTION OF THE INVENTION

Firstly, an optical pickup according to the present invention is a device for reproducing or/and recording information from or/and to an information recording medium by converging a laser beam emitted from a laser device, directing it to the information recording medium and receiving the light reflected by the information recording medium and may be referred to as an optical pickup device.

An optical pickup according to the present invention includes an objective lens for converging laser light and directing it to an information recording medium, a rotational frame member which surrounds the periphery of the objective lens, has a circular-shaped outer peripheral edge around an optical axis of the objective lens and rotates in conjunction with the objective lens, a lens holder which has a concave stepped portion for rotatably supporting the rotational frame member and is coupled to the rotational frame member after rotation adjustments, and a protruding portion protruded from the rotational frame member toward the information recording medium.

According to the present invention, the lens holder (lens installation table) has a concave stepped portion for rotatably supporting the rotational frame member and is coupled to the rotational frame member after adjustments of the rotation of the rotational frame member which rotates in conjunction with the objective lens, in such a way as to minimize the influence of birefringence at the objective lens. The rotational frame member has a circular-shaped outer peripheral edge, which makes it easier to perform rotation adjustments along the concave stepped portion of the lens holder.

According to the present invention, there is installed the rotational frame member which surrounds the peripheral edge of the objective lens, particularly the peripheral edge thereof near an information recording medium, and rotates in conjunction with the objective lens about the optical axis of the objective lens, in order to enable adjustments of the rotation of the objective lens. For example, the objective lens can have an elongated portion extending outwardly in the radial direction from its outer edge, more specifically a bar-shaped member, and the rotational frame member can have an engagement portion which engages with the aforementioned elongated portion, more specifically an engagement concave portion, which can simplify the mechanism for rotating the objective lens through the rotational frame member such that they move in conjunction with each other.

According to the present invention, the objective lens can have an outer peripheral edge in an irregular circular shape formed by eliminating a partial arc-shaped portion from a circular shape, and the elongated portion of the objective lens can falls within the range of the eliminated arc-shaped portion of the objective lens, namely the elongated portion of the objective lens can be structured not to protrude from the imaginary circumferential portion at the outer peripheral edge of the objective lens, which can reduce the length of the elongated portion of the objective lens in the radial direction. Further, since the objective lens itself has a nearly circular shape, there is no need for defining the rotational position thereof in holding the objective lens in the rotation mechanism, which makes it easier to place it and enables applying an adhesive material thereto using the periphery of the elongated portion. Further, the surface of the rotation mechanism to be coupled to the objective lens can be shaped in conformance to the outer edge shape of the objective lens, which makes it easier to achieve movement of the objective lens and the rotation mechanism in conjunction with each other.

In the present invention, it is preferable to form the elongated portion of the objective lens from a resin part formed by a gate during the formation of the objective lens, since there is no need for forming the elongated portion separately using a die.

The objective lens can be made of a synthetic resin such as olefin-based resin, which can offer an objective lens having a smaller weight with a reduced cost.

The protruding portion provided to the rotational frame member can also serve as lugs for supporting the frame member, in performing rotation adjustments manually (using tweezers or the like) or automatically (using a jig device or the like). Further, preferably, the protruding portion protruded from the rotational frame member toward the information recording medium can be provided with a concave portion at the center portion thereof when viewed in the direction of the protrusion, which causes the protruding portion to have a shape capable of being easily supported in manual or automatic rotation adjustments.

Further, preferably, the protruding portion comprises 4 or more protruding portions, and the protruding portions can be provided at even angular intervals along a circumstance about the rotation axis of the rotational frame member, which can certainly prevent the impingement of the objective lens, regardless of the rotational angular position at which the rotational frame member is secured.

In the present invention, in mounting and securing the objective lens to the rotational frame member, it is preferable that the aforementioned rotational frame member has a cutout (for example, a cavity with a volume of about 0.2 cc) faced with the objective lens, in its surface coupled to the aforementioned objective lens, which can prevent the adhesive agent from flowing out and intruding into portions other than the gap between the rotational frame member and the objective lens. Further, the cutout can be effectively utilized as relief portions for a jig for supporting the objective lens, in cases where the objective lens is mounted or is detached depending on circumstances.

Further, the rotational frame member can have tooth portions at its outer peripheral edge, and the lens holder can have a stopper to be disengageably engaged with the tooth portions of the rotational frame member, in the concave stepped portion formed therein, which makes it easier to maintain the position of the rotational frame member after rotation adjustments, in adjusting the rotation of the objective lens through the rotational frame member, thereby making it easier to perform subsequent operations for coupling the rotational frame member to the lens holder by, for example, injecting an adhesive agent therebetween. This can also stabilize the operation for securing the rotational frame member, thereby enabling fabrication of a high-quality optical pickup.

Further, the rotational frame member can have tooth portions at its outer peripheral edge, and the lens holder can have a driving gear to be disengageably engaged with the tooth portions of the rotational frame member for rotating the objective lens, in the concave stepped portion formed therein, which enables rotating the objective lens through the driving gear and the rotational frame member, thereby preventing tweezers or a jig from contacting with the objective lens to damage it and also enables fine rotation adjustments.

According to another aspect of the present invention, there is an information recording/reproducing device for reproducing or/and recording information by converging laser light emitted from a laser device, directing it to an information recording medium and receiving the light reflected by the information recording medium, the information recording/reproducing device comprising:

an optical pickup comprising:
an objective lens for converging laser light and directing it to an information recording medium;
a rotational frame member which surrounds the periphery of the objective lens, has a circular-shaped outer peripheral edge around an optical axis of the objective lens and rotates in conjunction with the objective lens;
a lens holder which has a concave stepped portion for rotatably supporting the rotational frame member and is coupled to the rotational frame member after rotation adjustments; and
a protruding portion protruded from the rotational frame member toward the information recording medium; and

a table being adapted such that an information recording medium can be mounted thereon and the laser light can be directed to the information recording medium through the objective lens in the optical pickup.

Hereinafter, embodiments of an optical pickup according to the present invention will be described, with reference to the drawings.

### FIRST EMBODIMENT

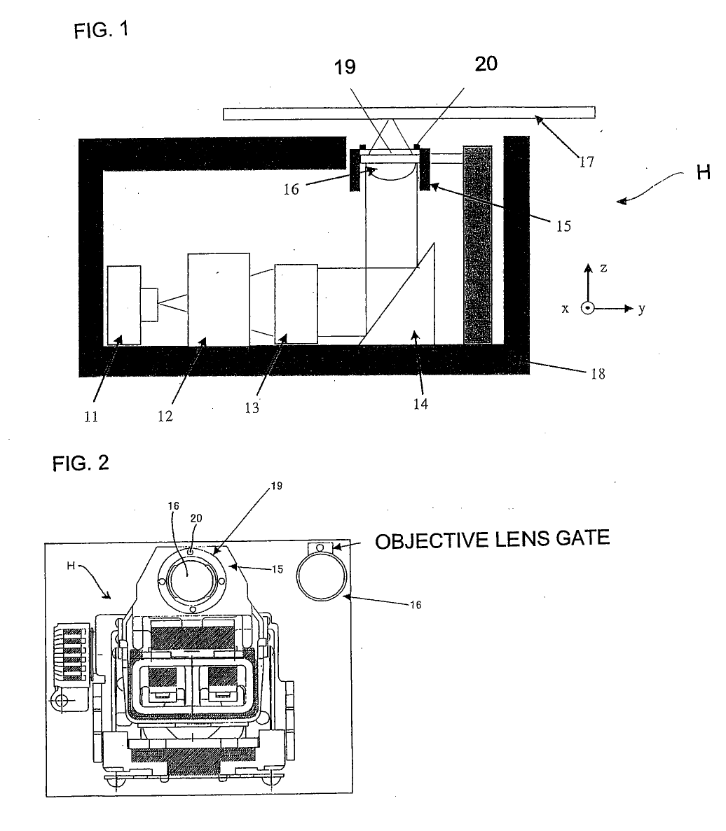

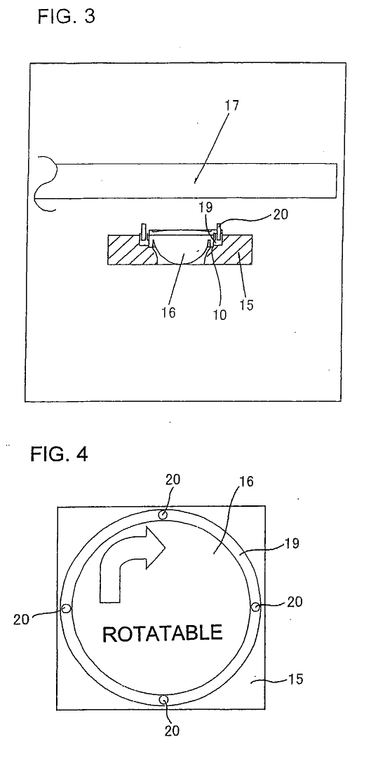

FIG. 1 is a schematic explanation view illustrating the entire structure of a first embodiment of an optical pickup according to the present invention. FIG. 2 is a plan view of FIG. 1. FIG. 3 is a main-part enlarged cross-sectional view of FIG. 2. FIG. 4 is a main-part enlarged plan view of FIG. 2.

Firstly, in the optical pickup H illustrated in FIG. 1, radiated light emitted from an integrated light receiving/emitting device 11 is reflected by or passed through a dichroic prism 12, then is converted into parallel light by a collimate lens 13 and then is reflected upwardly by a turn-up mirror 14. Thereafter, the parallel light is passed through an objective lens 16 mounted to a drivable and controllable lens holder 15, which causes the parallel light to be converted into converged light and to be converged and reflected at a single point on an optical disk 17 as a recording medium.

Then, the reflected light is passed through the condenser lens 16, again, to be converted into parallel light, then is reflected by the turn-up mirror 14, then is passed through the collimate lens 13, then is reflected by or passed through the dichroic prism 12 and is returned to the integrated light receiving/emitting device 11 along the path opposite from the forward path.

The returned light is divided by a diffraction grating at the surface of the integrated light receiving/emitting device 11 and reaches a light receiving portion which converts the optical signals into electric signals to be used for reproducing, recording and erasing information or used as serve signals. Further, “18” designates a housing of the optical pickup H.

Next, in FIGS. 1 to 4, the optical pickup H includes the objective lens (condenser lens) 16 made of an olefin-based resin material for converging laser light and directing it to an optical disk 17 as an information recording medium, a rotational frame member 19 which surrounds the peripheral edge of the objective lens 16, has a circular-shaped outer peripheral edge about the optical axis of the objective lens 16 and rotates in conjunction with the objective lens 16, the lens holder 15 which has a concave stepped portion 10 for rotatably supporting the rotational frame member 19 and is coupled to the rotational frame member 19 after rotation adjustments, and four protruding portions 20, 20, . . . which are protruded from the rotational frame member 19 toward the optical disk 17 and placed at even angular intervals along a circumference about the rotation axis of the rotational frame member 19.

As described above, the objective lens 16 is provided with the rotational frame member 19 which surrounds the periphery of the objective lens 16 and rotates in conjunction therewith about the optical axis of the objective lens 16, which enables easily adjusting the rotation of the objective lens 16 by rotating (turning) the rotational frame member 19.

Further, the rotational frame member 19 has the protruding portions 20 oriented toward the optical disk 17, which prevents the impingement between the objective lens 16 and the optical disk 17 and also enables rotating the rotational frame member 19 by gripping the protruding portions 20 manually (with tweezers or the like) or automatically (with a jig device or the like), thereby enabling easily performing adjustment operations for minimizing the influence of birefringence at the objective lens 16.

In mounting the objective lens 16 to the rotational frame member 19, there is no need for defining the direction of mounting, which makes it significantly easier to perform rotation adjustments and securing operations, thereby enabling creation of a high-quality spot state at every optical picking up.

### Second Embodiment

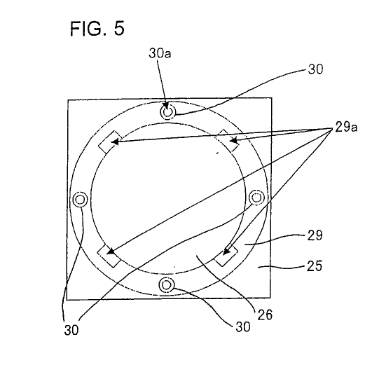

FIG. 5 is a view illustrating a second embodiment of the present invention, corresponding to FIG. 4 regarding the first embodiment.

Next, in FIG. 5, an optical pickup includes an objective lens (condenser lens) 26 made of an olefin-based resin material for converging laser light and directing it to an optical disk (not illustrated) as an information recording medium, a rotational frame member 29 which surrounds the peripheral edge of the objective lens 26, has a circular-shaped outer peripheral edge about the optical axis of the objective lens 26 and rotates in conjunction with the objective lens 26, a lens holder 25 which has a concave stepped portion for rotatably supporting the rotational frame member and is coupled to the rotational frame member 29 after rotation adjustments, and four protruding portions 30, 30, . . . which are protruded from the rotational frame member 29 toward the optical disk and placed at even angular intervals along a circumference about the rotation axis of the rotational frame member 29.

The other structures are the same as those of the first embodiment and will not be described herein.

As described above, the objective lens 26 is provided with the rotational frame member 29 which surrounds the periphery of the objective lens 26 and rotates in conjunction therewith about the optical axis of the objective lens 26, which enables easily adjusting the rotation of the objective lens 26 by rotating (turning) the rotational frame member 29.

Further, the rotational frame member 29 has the protruding portions oriented toward the optical disk, which prevents the impingement between the objective lens 26 and the optical disk and also enables rotating the rotational frame member 29 by gripping the protruding portions 30 manually (with tweezers or the like) or automatically (with a jig device or the like), thereby enabling easily performing adjustment operations for minimizing the influence of birefringence at the objective lens 26.

In this case, the impingement preventing protruding portions 30 each have a concave portion 30a at the center position of its tip end in the direction of the protrusion, which enables easily rotating the rotational frame member 29 by utilizing the concave portions 30a as portions to be manually or automatically grappled, in rotating the rotational frame member 29.

Further, the rotational frame member 29 which is faced with the objective lens 26 has cutouts 29a at four positions which are evenly spaced apart from one another, in its surface coupled to the objective lens 26. It is possible to drop a liquid-type adhesive agent (for example, a UV-curable acrylic-based resin material) into the cutouts 29a for preventing the adhesive agent from being flowed out therefrom. Further, in mounting the objective lens 26 to the rotation frame member 29 or in detaching the objective lens 26 from the rotation frame member 29 before dropping an adhesive agent, the cutouts 29a can be effectively utilized as jig relief portions.

In mounting the objective lens 26 to the rotational frame member 29, there is no need for defining the direction of mounting, which makes it significantly easier to perform rotation adjustments and securing operations, thereby enabling creation of a high-quality spot state at every optical picking up.

### Third Embodiment

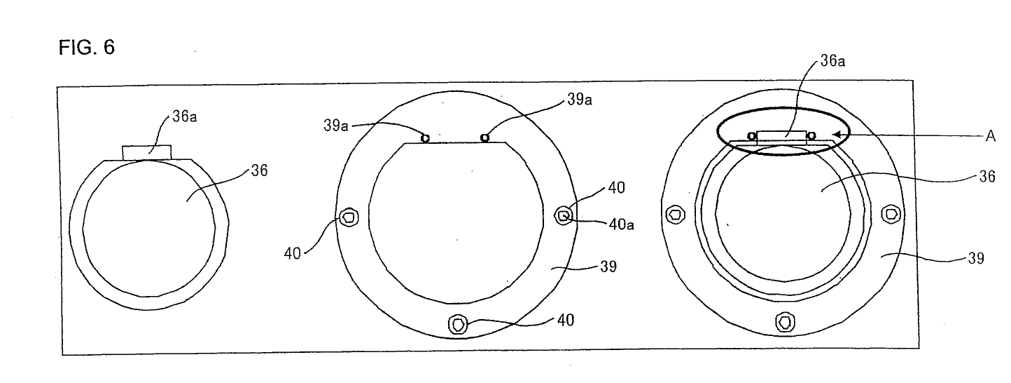

FIG. 6 is a structural explanation view illustrating a third embodiment of the present invention, illustrating an objective lens, a rotational frame member and a state where they are assembled, from the left side.

Next, in FIG. 6, an optical pickup includes an objective lens (condenser lens) 36 made of an olefin-based resin material for converging laser light and directing it to an optical disk (not illustrated) as an information recording medium, and a rotational frame member 39 which surrounds the peripheral edge of the objective lens 36, has a circular-shaped outer peripheral edge about the optical axis of the objective lens 36 and rotates in conjunction with the objective lens 36.

The other structures are the same as those of the first embodiment and will not be described herein.

As described above, the objective lens 36 is provided with the rotational frame member 39 which surrounds the peripheral edge of the objective lens 39 and rotates in conjunction therewith about the optical axis of the objective lens 36, which enables easily adjusting the rotation of the objective lens 36 by rotating (turning) the rotational frame member 39.

Further, the objective lens 36 has an irregular circular-shaped outer peripheral edge formed by eliminating a partial arc-shaped portion from a circular shape and has a convex portion 36a as an elongated portion formed at the eliminated portion.

In conformance thereto, the rotational frame member 39 has an irregular circular-shaped hole portion and has a pair of convex-shaped securing mechanisms 39a and 39b. Thus, the convex-shaped portion 36a of the objective lens 36 is pushed into the gap between the pair of convex-shaped securing mechanisms 39a and 39b as illustrated in an enclosed portion A, which causes the objective lens 36 to be coupled to the rotational frame member 39 such that they rotate in conjunction with each other about the optical axis of the objective lens.

Further, the rotational frame member 39 has protruding portions 40 oriented toward an optical disk (not illustrated), which prevents the impingement between the objective lens 36 and the optical disk 37 and also enables rotating the rotational frame member 39 by gripping the protruding portions 40 manually (with tweezers or the like) or automatically (with a jig device or the like), thereby enabling easily performing adjustment operations for minimizing the influence of birefringence at the objective lens 36.

In this case, the aforementioned protruding portions 40 each have a concave portion 40a at the center position of its tip end in the direction of the protrusion. In rotating the rotational frame member 39, it is possible to utilize the concave portions 40a as portions to be manually or automatically grappled for rotating the rotational frame member 39, during operations for adjusting the rotational position of the objective lens, which enables easily performing adjustment operations for minimizing the influence of birefringence at the objective lens 36.

### FOURTH EMBODIMENT

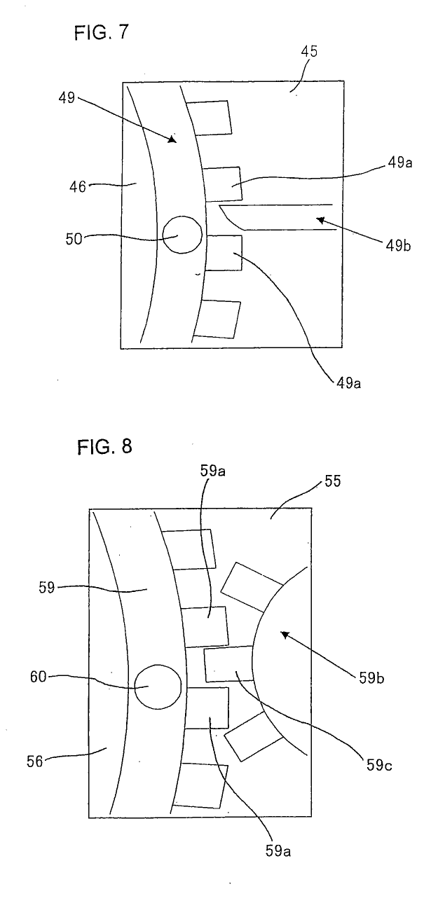

FIG. 7 is a main-part enlarged view illustrating a fourth embodiment of the present invention.

In FIG. 7, a rotational frame member 49 which rotates in conjunction with an objective lens 46 has tooth portions 49a at its peripheral edge, and a lens holder 45 has a stopper 49b to be disengageably engaged with the tooth portions 49a of the rotational frame member 49 in performing adjustments of the rotation of the rotational frame member 49 which moves in conjunction with the objective lens 46. With this structure, it is possible to maintain accurately the position of the rotational frame member 49 after the rotation adjustments, thereby preventing the occurrence of deviations of the position of the rotational frame member 49 and enabling adjustment of the rotational position thereof with higher accuracy, in performing subsequent adhering operations. Further, there is no need for touching the portion around the objective lens 46, thereby reducing the risk of damaging the objective lens 46. Further, “50” designates protruding portions which protrude from the rotational frame member 49. The other structures are the same as those of the first embodiment and will not be described herein.

### FIFTH EMBODIMENT

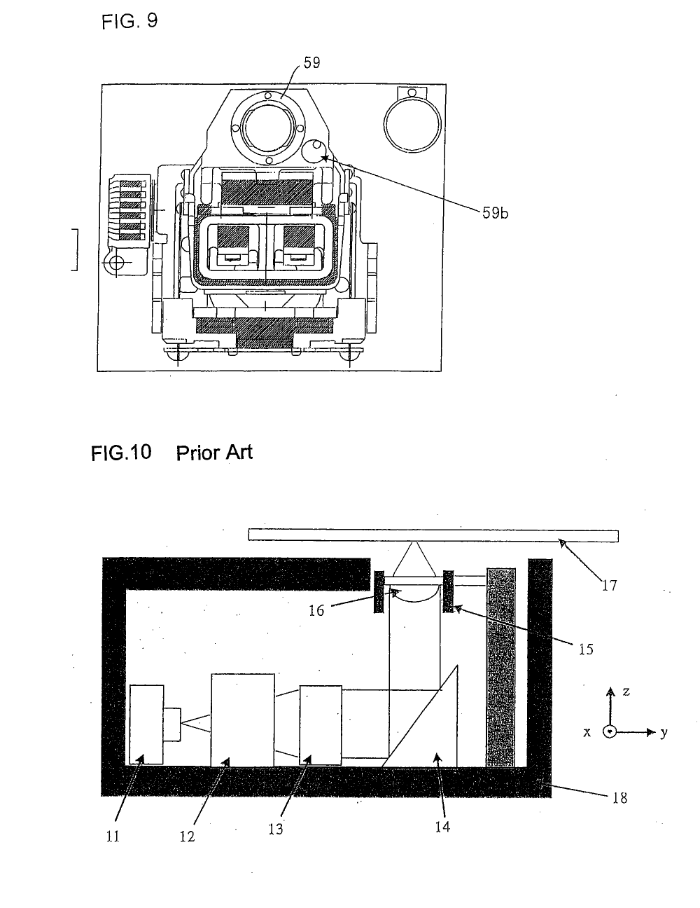

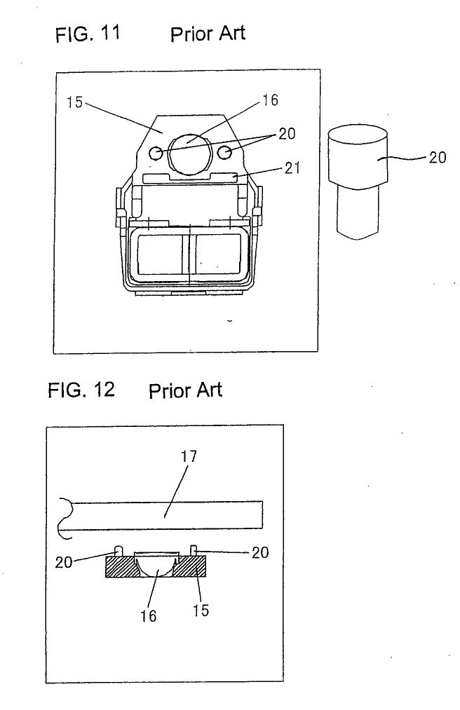

FIG. 8 is a view illustrating a fifth embodiment of the optical pickup according to the present invention, corresponding to FIG. 7 described in the fourth embodiment, and FIG. 9 is a view of the fifth embodiment, corresponding to FIG. 2 described in the first embodiment.

In FIGS. 8 and 9, a rotational frame member 59 which rotates in conjunction with an objective lens 56 has tooth portions 59a at its peripheral edge, and a lens holder 55 has a driving gear 59b having tooth portions 59c to be disengageably engaged with the tooth portions 59a of the rotational frame member 59 for rotating the objective lens 56 in performing adjustments of the rotation of the rotational frame member 59 which moves in conjunction with the objective lens 56.

With this structure, it is possible to perform accurately fine adjustments of the rotational angle of the rotational frame member 59 and also it is possible to maintain accurately the position of the rotational frame member 59 after the rotation adjustments, thereby preventing the occurrence of deviations of the position of the rotational frame member 59 and enabling adjustment of the rotational position thereof with higher accuracy, in performing subsequent adhering operations. Further, there is no need for touching the portion around the objective lens 56, thereby reducing the risk of damaging the objective lens 56. Further, “60” designates protruding portions which protrude from the rotational frame member 59. The other structures are the same as those of the first embodiment and will not be described herein.

As described above, the optical pickup according to the present invention enables preventing the objective lens from being damaged during adjustments, improving the operability of the objective lens in adjustments of the rotation of the objective lens and preventing the impingement of the objective lens certainly, by performing adjustments of the rotation of the rotational frame member which surrounds the peripheral edge of the objective lens, has a circular-shaped outer peripheral edge about the optical axis of the objective lens and rotates in conjunction with the objective lens during adjustment processing for minimizing the influence of birefringence at the objective lens.

Therefore, with the optical pickup according to the present invention, it is possible to provide, stably, an optical pickup with high performance and high reliability, in an optical pickup device incorporated in a conventional thin notebook-type personal computer or used with a next-generation optical disk system which utilizes blue laser, as well as an optical pickup for a vehicle. This can increase the performance of the optical pickup device and can improve the yield thereof, thereby reducing the cost therefor.

What is claimed is:

1. An optical pickup comprising:
an objective lens for converging laser light and directing it to an information recording medium;
a rotational frame member which surrounds the periphery of the objective lens, has a circular-shaped outer peripheral edge around an optical axis of the objective lens and rotates in conjunction with the objective lens;
a lens holder which has a concave stepped portion for rotatably supporting the rotational frame member and is coupled to the rotational frame member after rotation adjustments; and
a protruding portion protruded from the rotational frame member toward the information recording medium.

2. The optical pickup according to claim 1, wherein
the objective lens has an elongated portion extending outwardly in the radial direction from its outer edge, and the rotational frame member has an engagement portion which engages with the elongated portion.

3. The optical pickup according to claim 2, wherein
the elongated portion of the objective lens is a bar-shaped member, and the engagement portion of the rotational frame member is an engagement concave portion which engages with the bar-shaped member.

4. The optical pickup according to claim 2, wherein
the objective lens has an outer peripheral edge in an irregular circular shape formed by eliminating a partial arc-shaped portion from a circular shape, and the elongated portion of the objective lens falls within the range of the eliminated arc-shaped portion of the objective lens.

5. The optical pickup according to claim 1, wherein the objective lens is made of a synthetic resin.

6. The optical pickup according to claim 5, wherein the elongated portion of the objective lens is formed by a gate during the formation of the objective lens.

7. The optical pickup according to claim 1, wherein the protruding portion protruded from the rotational frame member toward the information recording medium has a concave portion at the center portion thereof, when viewed in the direction of the protrusion.

8. The optical pickup according to claim 1, wherein the protruding portion comprises 4 or more protruding portions.

9. The optical pickup according to claim 1, wherein the rotational frame member has a cutout faced with the objective lens, in its surface coupled to the objective lens.

10. The optical pickup according to claim 1, wherein the rotational frame member has tooth portions at its outer peripheral edge, and the lens holder has a stopper to be disengageably engaged with the tooth portions of the rotational frame member, in the concave stepped portion formed therein.

11. The optical pickup according to claim 1, wherein the rotational frame member has tooth portions at its outer peripheral edge, and the lens holder has a driving gear to be disengageably engaged with the tooth portions of the rotational frame member, at a portion of the concave stepped portion formed therein.

12. An information recording/reproducing device for reproducing or/and recording information by converging laser light emitted from a laser device, directing it to an information recording medium and receiving the light reflected by the information recording medium, the information recording/reproducing device comprising:
an optical pickup comprising:
an objective lens for converging laser light and directing it to an information recording medium;
a rotational frame member which surrounds the periphery of the objective lens, has a circular-shaped outer peripheral edge around an optical axis of the objective lens and rotates in conjunction with the objective lens;
a lens holder which has a concave stepped portion for rotatably supporting the rotational frame member and is coupled to the rotational frame member after rotation adjustments; and
a protruding portion protruded from the rotational frame member toward the information recording medium; and
a table being adapted such that an information recording medium can be mounted thereon and the laser light can be directed to the information recording medium through the objective lens in the optical pickup.
